(19) United States
(12) Patent Application Publication
(10) Pub. No.: US 2018/0268327 A1
(43) Pub. Date: Sep. 20, 2018

(54) Multi-Layer Adaptive Power Demand Management For Behind The Meter Energy Management Systems

(71) Applicant: NEC Laboratories America, Inc., Princetion, NJ (US)

(72) Inventors: Ali Hooshmand, San Jose, CA (US); Ramin Moslemi, Athens, GA (US); Ratnesh Sharma, Fremont, CA (US)

(21) Appl. No.: 15/789,068

(22) Filed: Oct. 20, 2017

Related U.S. Application Data
(60) Provisional application No. 62/473,646, filed on Mar. 20, 2017.
(60) Provisional application No. 62/546,027, filed on Aug. 16, 2017.

(51) Int. Cl. G06Q 10/04; G06Q 50/06; G05B 15/02

(52) U.S. Cl. CPC G06Q 10/04; G05B 19/048; G05B 15/02; G06Q 50/06

(57) ABSTRACT

Systems and methods for adaptive demand charge management in a behind the meter energy management system. The system and method includes determining, in a first layer, an initial demand charge threshold (DCT), for a first period, based on historical DCT profiles, and generating recursively, in a second layer, a forecast of a power demand for a second period, wherein the second period is a subset of the first period. Further included is combining the first layer and the second layer to recursively modify the initial DCT with a DCT adjustment value to generate a modified DCT, wherein the DCT adjustment value is optimized according to the forecast of power demand for the second period, and controlling batteries according to the modified DCT, wherein the batteries are discharged if power demand is above the modified DCT, and the batteries are charged if the power demand is below the modified DCT.

### RELATED APPLICATION INFORMATION

This application claims priority to 62/473,646, filed on Mar. 20, 2017, incorporated herein by reference herein its entirety, and to 62/546,027, filed on Aug. 16, 2017, incorporated herein by reference herein its entirety.

### BACKGROUND

### Technical Field

The present invention relates to power management systems and more particularly to a multi-layer demand charge management solution for behind the meter battery storage for minimizing demand costs and battery degradation.

### Description of the Related Art

Consumers are often charged by demand network operators (DNO's) for both total energy use as well as power demand. Accordingly, up to 50% of a commercial/industrial consumer's monthly power bill may be due to maximum power demand delivered from the grid during a billing period which is called demand charge. As a result, minimizing the maximum monthly power demand stands to significantly reduce the costs of a consumer. In order to achieve cost reductions, behind the meter energy management systems (BTM-EMS) have been developed, often using batteries to supplement power supplied by a DNO.

However, current BTM-EMSs tend to have low accuracy in determining an amount of demand to be supplied by batteries. As a result, the BTM-EMS may under or overestimate the demand which may lead to unnecessary degradation of the batteries or ineffective reductions of demand charge respectively.

Accordingly, a better solution for forecasting demand is necessary to better optimize the charging and discharging schedule of batteries in a BTM-EMS in order to reduce demand charges while preventing degradation of batteries.

### SUMMARY

According to an aspect of the present principles, a method is provided for adaptive demand charge management in a behind the meter energy management system. The method includes determining, in a first layer, an initial demand charge threshold (DCT), for a first period, based on historical DCT profiles. The method further includes generating recursively, in a second layer, a forecast of a power demand for a second period, wherein the second period is a subset of the first period. The method may further include combining the first layer and the second layer to recursively modify the initial DCT with a DCT adjustment value to generate a modified DCT, wherein the DCT adjustment value is optimized according to the forecast of power demand for the second period. The method further includes controlling batteries according to the modified DCT, wherein the batteries are discharged if power demand is above the modified DCT, and the batteries are charged if the power demand is below the modified DCT.

According to another aspect of the present principles, a system is provided for adaptive power demand management in a behind the meter energy management system. The system includes a first layer forecaster, including a processor, configured to determine an initial demand charge threshold (DCT), for a first period, based on historical DCT profiles, and a second layer forecaster configured to generate recursively a forecast of a power demand for a second period, wherein the second period is a subset of the first period. Further included is an optimizer configured to combine the first layer forecaster and the second layer forecaster to recursively modify the initial DCT with a DCT adjustment value to generate a modified DCT, wherein the DCT adjustment value is optimized according to the forecast of power demand for the second period. The system may include a real-time battery storage controller configured to control batteries according to the modified DCT, wherein the batteries are discharged if power demand is above the modified DCT, and the batteries are charged if the power demand is below the modified DCT.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for multi-layer power demand management, in accordance with the present principles;

FIG. 2 is a block/flow diagram illustrating a system/method for a multilayer power demand management controller, in accordance with the present principles;

FIG. 3 is a flow diagram illustrating a system/method for a monthly layer for the forecasting of power demand for multi-layer power demand management, in accordance with the present principles;

FIG. 4 is a flow diagram illustrating a system/method for a daily layer for the forecasting of power demand for multi-layer power demand management, in accordance with the present principles; and

FIG. 5 is a flow diagram illustrating a system/method for real-time battery control in multi-layer power demand management, in accordance with the present principles.

### DETAILED DESCRIPTION OF PREFERRED EMBODIMENTS

In accordance with the present principles, systems and methods are provided for a multi-layer power demand management control.

In one embodiment, the multi-layer power demand management control includes a first layer and at least a second layer in order to optimize a demand charge threshold (DCT) for determining whether to charge or discharge batteries in a BTM-EMS, where the battery will discharge power to the customer when the DCT is exceeded.

The first layer provides a data driven optimal DCT forecast for a billing period. The forecast may be determined according to historical power demand or DCT data. The historical data may come from an instant customer or from other customers if the instant customer does not have enough historical data. By taking into account historical DCT values, historical load profiles, demand charge tariff rates and battery specifications, the first layer can provide an near optimal initial DCT value for decreasing demand charges in the a billing period.

However, because short term irregularities may occur that would not be predicted by data from relatively long time periods of the billing period (e.g. monthly time periods), the DCT from the first layer can be further optimized on a shorter term basis with a second layer. The second layer can cover a second period that is a subset of the billing period (e.g., a billing period of months, and a second time period of days within a month), and thus provide a shorter term optimization than the first layer alone.

The second layer may forecast power demand for the coming day using the history of the load profile. Such a technique may include a load forecast for the coming day using a time series model, such as an auto-regressive integrated moving average (ARIMA) or a seasonal ARIMA. By determining a load forecast for the second time period (e.g. the next 24 hours), the DCT from the first layer is modified recursively. The modification may be performed according to a rolling time horizon optimization technique that modifies the DCT according to the load forecast in order to determine an updated DCT value. The updated DCT may, for example, be in the form of a minimum achievable increase in the DCT value according to the forecasted load.

By combining the first layer with at least the second layer, the multi-layer demand charge management control can forecast the DCT value for the billing period and refine the DCT value on the shorter term basis to reduce error in the DCT for the second time period. The recursive modification of the DCT using the second layer ensures that an optimal demand charge reduction is achieved regardless of the existing error in the initial DCT values. Thus, the multi-layer approach can predict underestimation of the DCT and provide a more accurate DCT value on a short term, such as a daily basis, such that the DCT is optimized to decrease demand charges. Preventing underestimation in particular, may be particularly beneficial because such underestimation of the DCT can result in excessive charging and discharging of the batteries in the BTM-EMS, therefore causing excessive degradation of the batteries. Such degradation can prove costly by requiring replacement of the batteries.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

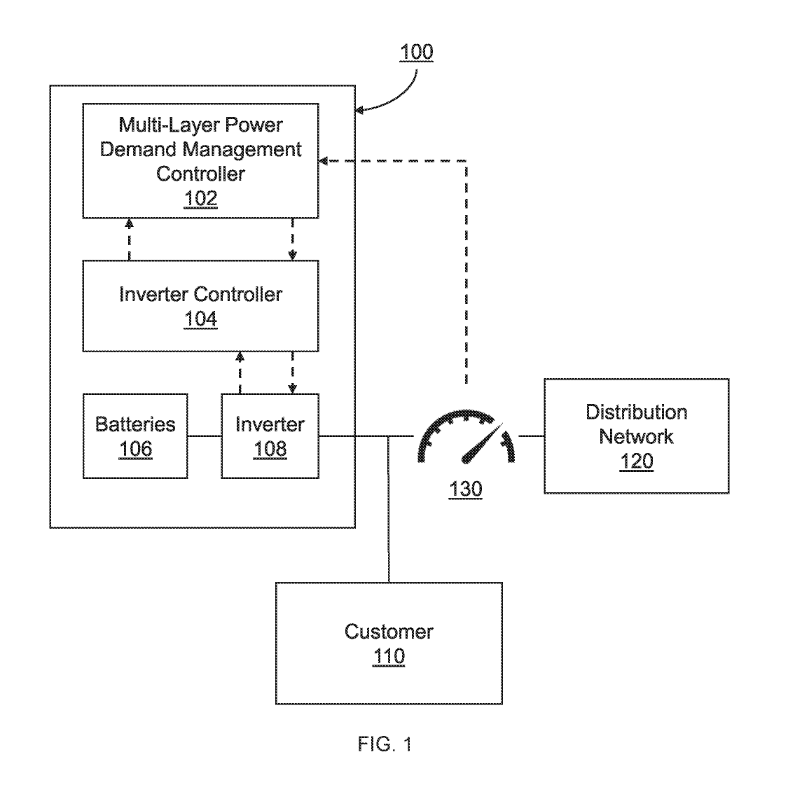

Referring now in detail to the figures in which like numerals represent the same or similar elements and initially to FIG. 1, a high-level system/method for a multi-layer adaptive power demand management control is illustratively depicted in accordance with one embodiment of the present principles.

In one embodiment, the multi-layer adaptive demand charge management control includes a behind the meter energy management system (BTM-EMS) 100. As the customer 110 draws power from the distribution network 120, a meter 130 monitors the customer's 110 power demand. The BTM-EMS 100 may, therefore, be configured to detect the power demand with the meter 130, and control charging and discharging of batteries to manage power transactions with the distribution network 120.

The BTM-EMS 100 may control the batteries 106 using a multi-layer power demand management controller 102. According to one aspect of the invention, the multi-layer demand charge management controller 102 may include two or more layers of optimizing a demand charge threshold (DCT). The DCT may be used by the BTM-EMS 100 to determine at what point, and to what extent, the power demand by the customer should be supplemented with power from the batteries 106. According to an aspect of the invention, the two or more layers may include, for example, a monthly layer and a daily layer, however other layers could be used (e.g. yearly, seasonally, weekly, hourly, etc.).

The two or more layers of the multi-layer power demand management controller 102 ensure that the DCT is optimized with minimal error by forecasting an optimal DCT over a relatively long period using a first layer (for example, a billing period such as a month). The forecasted DCT may then be further optimized using at least one subsequent layer that adjusts the DCT based on a relatively shorter period forecast of power demand to address unpredicted power demand changes. Each layer of the multi-layer power demand management controller 102 may include data driven determinations according to past behavior. For example, the forecasted DCT in the first layer may be determined according historical data of either the customer's 110 power demand history, or the power demand history of other customers if the instant customer 110 does not have sufficient power demand history for an accurate forecast.

Upon determining an optimum DCT, the multi-layer power demand management controller 102 may perform real-time battery control using an inverter controller 104 to control an inverter 108. The inverter controller 104 may control the inverter 108 according to the DCT optimized by the multi-layer power demand management controller 102 to discharge the batteries 106 when power demand rises above the DCT, thus supplementing power demanded from the distribution network 120.

Accordingly, the BTM-EMS 100 may reduce demand peaks in the case that demand rises above a certain DCT value. Because customers are charged based on energy consumed and peak power demand in a billing period (a billing period often being a month), peak power demand can result in up to 50% of a customer's power bill. As a result, the reduction in power demand peaks stands to significantly reduce a customer's power charges by reducing demand charges. The use of a demand charge management controller having multiple layers 102, error can be minimized. For example, underestimation of DCT can be prevented. By preventing underestimation of the DCT, the BTM-EMS 100 can prevent unnecessary charging and discharging of the batteries 106, and thereby reducing degradation of the batteries 106, therefore increasing the lifespan of the batteries 106.

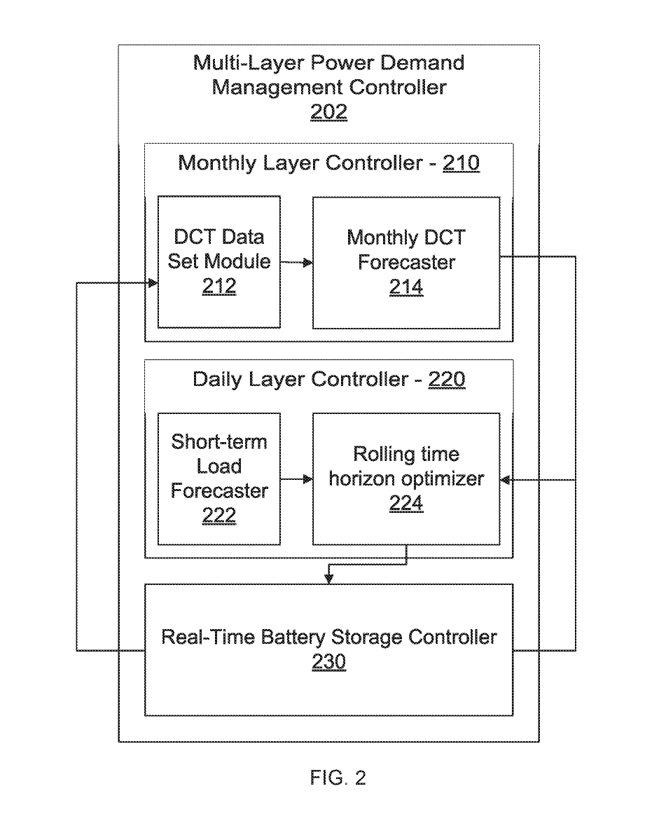

Referring now to FIG. 2, a system/method for multi-layer power demand management controller is illustratively depicted in accordance with an embodiment of the present principles.

According to an aspect of the present invention, a multi-layer power demand management controller 202 may be used. The multi-layer power demand management controller 202 may include a monthly layer controller 210, a daily layer controller 220 and real-time battery storage controller 230.

The monthly layer controller 210 may include a DCT data set module 212. The DCT data set module 212 may include, for example, a computer memory or a buffer for storing a DCT data set. The DCT set may include historical data of load profiles, DCT values, demand charge tariff rates and battery specifications, or the DCT set may be preprocessed to include a set of relevant DCT profiles based on the historical data.

Using the DCT data set from the DCT data set module 212, the monthly layer controller 210 forecasts a DCT value for the coming month using a monthly DCT forecaster 214. The monthly DCT forecaster 214 may be, for example, a computer processor. The monthly DCT forecaster 214 may utilize the DCT data set provided by the DCT data set module 212 to determine trends in historical data such as a plurality of DCT profiles including multiple months of DCT values. The DCT forecaster 214 can compare the plurality of DCT profiles a current DCT profile to determine trends for predicting an initial DCT value for the coming month.

The initial DCT value may then be adjusted by the daily layer controller 220 to ensure an accurate DCT value for a coming day. The daily layer controller 220 performs short-term load forecasting using a short-term load forecaster 222. The short-term load forecaster 222 may be, for example, a processor. The short-term load forecaster 222 may forecast load for the next day by retrieving load data for a given period, such as load profiles including demand behavior for each day over the past four weeks. The short-term load forecaster 222 may also perform a data cleansing operation to remove abnormal past load patterns from the data set, such as holidays. Using the load data, the short-term load forecaster 222 may use machine learning to predict the load for the next day. For example, the short-term load forecaster 222 may use a time series model, such as an auto-regressive integrated moving average (ARIMA) model to forecast the load for the coming day.

The forecasted load, along with the initial DCT value and a battery state of charge (SOC) may then be retrieved by a rolling time horizon optimizer 224 that adjusts the initial DCT value according to the forecasted load. The rolling time horizon optimizer 224 may be, for example, a processor. The rolling time horizon optimizer 224 may adjust the initial DCT value by optimizing an adjustment value that is the minimum achievable increase to the initial DCT value that will achieve a minimum demand peak while preventing unnecessary battery degradation. The optimization performed by the rolling time horizon optimizer 224 therefore can compensate error in the initial DCT value due to load irregularities as a result of factors such as weather. The rolling time horizon optimizer 224 may then add the adjustment value to the initial DCT value to generate a modified DCT value.

The modified DCT value will be retrieved by a real-time battery storage controller 230. The real-time battery storage controller 230 may be, for example, a processor. The real-time battery storage controller 230 uses the modified DCT value along with the SOC and battery specifications to make a determination as to whether to charge or discharge the batteries, or to take no action. The real-time battery storage controller 230 may then update the SOC and report the SOC to rolling time horizon optimizer 224 for later DCT optimization.

The multi-layer demand charge management controller 202, therefore, controls batteries of a BTM-EMS to only charge or discharge the batteries in a way that achieves an optimum balance between demand peak shaving, thus reducing costs. Also, since the proposed demand charge management solution starts each month with an initial estimation of a DCT value, it may prevent unnecessary battery charge and discharge cycles and may minimize battery degradation which may lead to maintenance cost reduction.

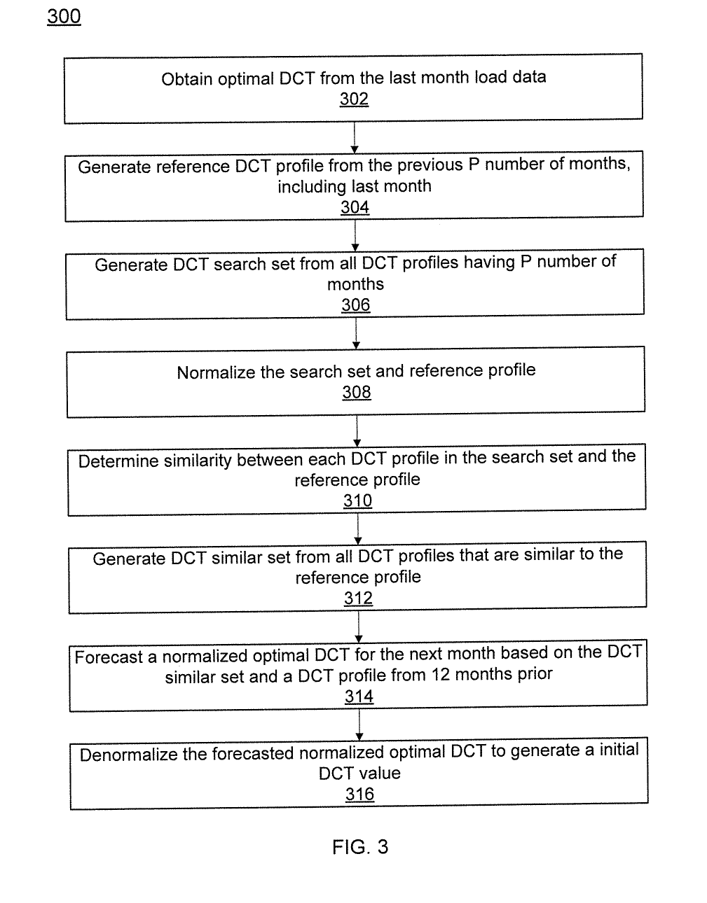

Referring now to FIG. 3, a system/method for a monthly layer 300 of a multi-layer demand charge management controller is illustratively depicted in accordance with an embodiment of the present principles.

The monthly layer 300 of the multi-layer demand charge management controller forecasts an initial DCT value for a coming month, using trends in historical monthly DCT values, historical load profiles, demand charge tariff rates and battery specifications.

At block 302, at the end of a most recent month, the monthly layer 300 may first calculate the optimal DCT for that month given the load profile, the demand charge tariff rates and the battery specifications for that month. The optimal DCT may calculated according to the following optimization problem:

$${min}_{{P}_{b}} DCT = {max}_{t} {P}_{g} ( t ) \\ s . t . {SOC}^{min} \leq SOC ( t ) \leq {SOC}^{max} ∀ t ∈ \{ 1 … n \} \\ {P}_{b}^{min} \leq {P}_{b} ( t ) \leq {P}_{b}^{max} ∀ t ∈ \{ 1 … n \} \\ {P}_{g} ( t ) + {P}_{b} ( t ) = {P}_{d} ( t ) ∀ t ∈ \{ 1 … n \} \\ SOC ( t ) = SOC ( t - 1 ) + {P}_{d} ( t - 1 ) Δ t ∀ t ∈ \{ 1 … n \} \qquad Equation 1$$

where t is the time step counter, n is the total number of the time steps in the whole billing period and Δt is the duration of each time step (i.e. 15 minutes). P_{g}(t) and P_{b}(t) are the active powers provided by grid and battery discharge respectively to provide active power demand by load P_{d}(t) at the time t. Also SOC^{min} and SOC^{max} are minimum and maximum allowed boundaries for the battery state of the charge and SOC(t) is the battery state of charge at time t. Finally, P_{b}^{min} and P_{b}^{max} defines battery power limits.

At block 304, the monthly layer 300 generates a reference DCT profile (DCT_{ref}) from the optimal DCT values calculated for each month in a period of operation of the battery system, wherein the period of operation may span a particular number of months P, including the most recent month. The DCT_{ref} may comprise a time series including the calculated optimal DCT value for each month in the period of operation P. Each optimal DCT value may have been previously calculated in a manner similar to step 302 using equation 1.

At block 306, the monthly layer 300 selects all DCT profiles having a same period of operation including P months as the DCT_{ref} period of operation. For example, if the period length P is one year, or twelve months, and the period of operation started in January and ended in December, the monthly layer 300 selects each DCT profile having DCT values for a series of 12 months spanning from January to December. All of these P-length DCT profiles are loaded into a DCT search set (DCT_{sch}).

At step 308, the monthly layer 300 then performs a normalization on the DCT_{ref} (D̅C̅T̅_{ref}) time series as well as each DCT series in the DCT_{sch} (D̅C̅T̅_{sch}) set. The normalization of the DCT profiles may be based on, for example, the average value of each DCT profile. The normalization step 308 ensures that all DCT profiles are in the same scale of variation. By normalizing all of the DCT profiles, the monthly layer 300 can more effectively determine similarity between DCT_{ref} and each DCT profile included in DCT_{sch}.

At block 310, the monthly layer 300 determines the similarity between D̅C̅T̅_{ref} and each DCT profile in D̅C̅T̅_{sch}. Determining similarity may include, for example, calculating the Euclidean distance between D̅C̅T̅_{ref} and each DCT profile in D̅C̅T̅_{sch}. However, other methods of determining similarity may be used, such as by calculating a Mikowski distance or a Pearson correlation coefficient.

At block 312, the monthly layer 300 selects a set of all similar DCT profiles among the DCT profiles in D̅C̅T̅_{sch}. The similarity is based, for example, on the calculated Euclidean distance between D̅C̅T̅_{ref} and each DCT profile in D̅C̅T̅_{sch} and a predetermined distance threshold. The predetermine distance threshold may be a value of the greatest distance for a profile to be deemed similar. The normalized DCT profiles that are determined to be similar are grouped into a DCT similar set (D̅C̅T̅^{s}) that can be used to forecast an initial DCT value for a coming month.

At block 314, the monthly layer 300 forecasts a normalized DCT for the coming month D̅C̅T̅ₜ₊₁ based on D̅C̅T̅^{s} and a normalized DCT value from a month 11 months prior D̅C̅T̅ₜ₋₁₁. For example, forecasting a DCT value for February of one year will include taking into account D̅C̅T̅^{s} and the normalized DCT value for February of the previous year. The forecasting may include calculating a forecasting equation such as equation 2 below:

$${\overline{DCT}}_{t + 1} = \frac{1}{M + 1} [ {\overline{DCT}}_{t - 11} + {Σ}_{i = 1}^{M} {\overline{DCT}}_{i}^{s} ] \qquad Equation 2$$

where M is the number of profiles D̅C̅T̅^{s}.

If D̅C̅T̅^{s} includes the DCT profile from the previous year, equation 2 may be adjusted to increase the weight of D̅C̅T̅ₜ₋₁₁ in order to account for seasonality in power loads. For example, the monthly layer 300 may adjust equation 2 as shown below in equation 3:

$${\overline{DCT}}_{t + 1} = \frac{1}{2 M - 2} [ ( M - 2 ) \times {\overline{DCT}}_{t - 11} + {Σ}_{i = 1}^{M} {\overline{DCT}}_{i}^{s} ] \qquad Equation 3$$

At block 316, the monthly layer 300 denormalizes D̅C̅T̅ₜ₊₁ to generate an initial DCT value for the coming month.

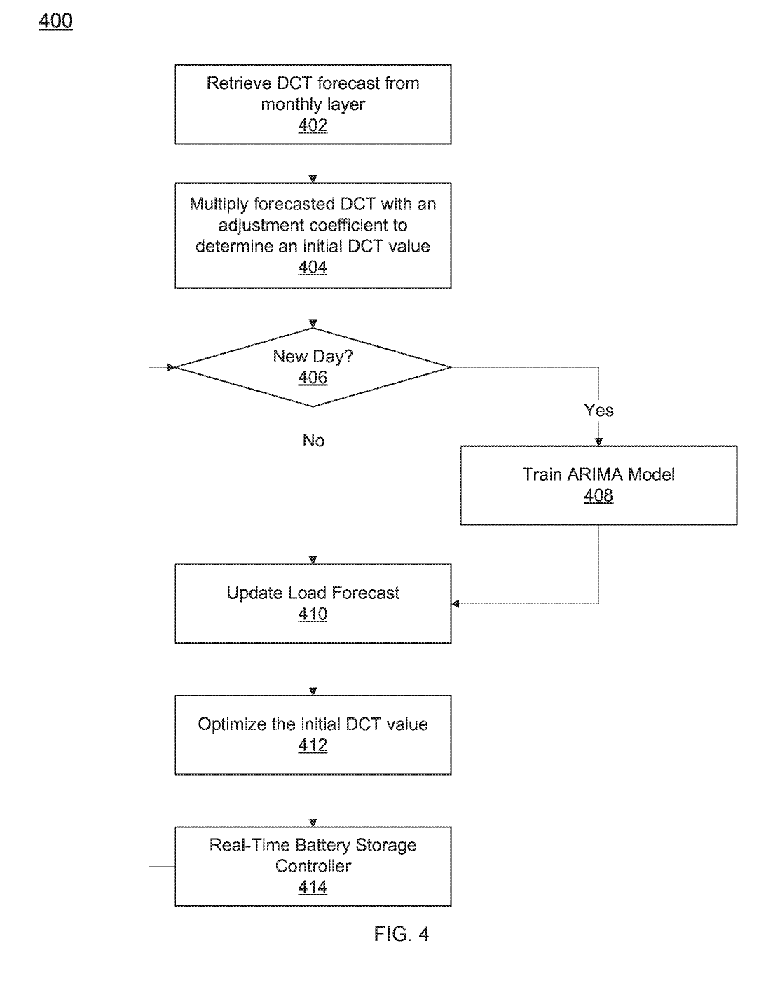

Referring now to FIG. 4, a system/method for a daily layer 400 of a multi-layer demand charge management controller is illustratively depicted in accordance with an embodiment of the present principles.

The daily layer 400 may calculate a modification for the initial DCT value (DCTᵢ) generated by the monthly layer. According to an aspect of the present invention, the daily layer 400 seeks to prevent underestimation of the DCT value because of the potential costly effects of degrading a battery through unnecessary charging and discharging and effect of DCT violations on the demand charge savings. The modification may be, for example, an increase of DCT value to fix an underestimation of the DCT for a given day with abnormal high demand peak. The daily layer 400 may determine that an underestimation exists by forecasting a load for a coming day and optimizing the modification to the initial DCT value according to the forecasted load to achieve effective peak shaving. In addition, the daily layer 400 may also seek to prevent overestimation of the initial DCT value in order to maximize the impact of the BTM-EMS.

For example, the daily layer 400 may retrieve the initial DCT value from the monthly layer 402. The daily layer 400 will then multiply the initial DCT value with an adjustment coefficient 404 (e.g. a positive number less than one). Accordingly, the adjustment coefficient adjusts the initial DCT value to produce an adjusted DCT value (DCT_{A}) that will be less likely to be deemed to be overestimated. The adjustment coefficient may be predetermined to balance accuracy with the risk of underestimation.

During a billing period operation, at every time step (e.g. 15 minutes), the daily layer 400 will then determine if the current time step is the beginning of a new day 406. If the current time step is the beginning a new day, the daily layer 400 will train a seasonal ARIMA model using historical load profiles to update the model parameters (e.g. the coefficients of the seasonal ARIMA model). In order to account for seasonality, a separate model is trained for each day of the week. For example, if the current time is the beginning of Monday, the seasonal ARIMA model is trained using previous Mondays load profiles. Therefore, the ARIMA model will be trained only with past load profiles for the same day of the week as is being forecasted. The order of the ARIMA model may be determined using auto-correlation and partial auto-correlation tests. The training data may include historical load profiles for the last four weeks.

Once the ARIMA model for the coming day has been trained, the daily layer 400 may updated the ARIMA model at every time step for the rest of the current day to calculate a load forecast for the next 24 hours using the latest historical load data.

Using the forecasted load for the next 24 hours, the daily layer may modify DCT_{A} with an optimal increase coefficient (a). The optimization may be performed according to equation 4 below:

$${min}_{{P}_{b}} DCT = {DCT}_{A} + α \\ s . t . {P}_{g} ( t ) \leq {DCT}_{A} + α ∀ t ∈ \{ {t}_{0} … {t}_{0} + T \} \\ {SOC}^{min} \leq SOC ( t ) \leq {SOC}^{max} ∀ t ∈ \{ {t}_{0} … {t}_{0} + T \} \\ {P}_{b}^{min} \leq {P}_{b} ( t ) \leq {P}_{b}^{max} ∀ t ∈ \{ {t}_{0} … {t}_{0} + T \} \\ {P}_{g} ( t ) + {P}_{b} ( t ) = {\hat{P}}_{d} ( t ) ∀ t ∈ \{ {t}_{0} … {t}_{0} + T \} \\ SOC ( t ) = SOC ( t - 1 ) + {P}_{b} ( t - 1 ) Δ t ∀ t ∈ \{ {t}_{0} … {t}_{0} + T \} \\ α \geq 0 \qquad Equation 4$$

where \hat{P}_{d}(t) is the load forecast for time t, t₀ is the current time step, DCT_{A} is the current time step adjusted DCT value, T is length of time horizon (24 hours) and α is a positive variable which indicates the minimum increase in DCT value to prevent DCT violation.

The optimization problem of Equation 4 may be performed at regular intervals (e.g. 15 minutes) with the latest state of charge information for the battery from the real-time battery storage controller. 414. To deal with load forecast error, the monthly layer have reserved a portion of the battery capacity, in effect treating the batteries as having a smaller capacity than the actual specifications. The daily layer 400 may reintroduce the reserved capacity and replace SOCₘᵢₙ with SOCₘᵢₙ plus reserve capacity in the first steps of peak shaving. The daily layer 400 may then use the SOCₘᵢₙ plus reserve capacity value as the minimum state of charge after the battery SOC decreases to below a predetermined threshold (SOC_{threshold}).

As a result, the daily layer 400 modifies the initial DCT value according to a forecasted load and the current battery SOC. The modified DCT value represents an optimal balance between peak shaving and battery degradation. As a result, preventing DCT violation increasing the demand charge savings achieved by the BTM-EMS.

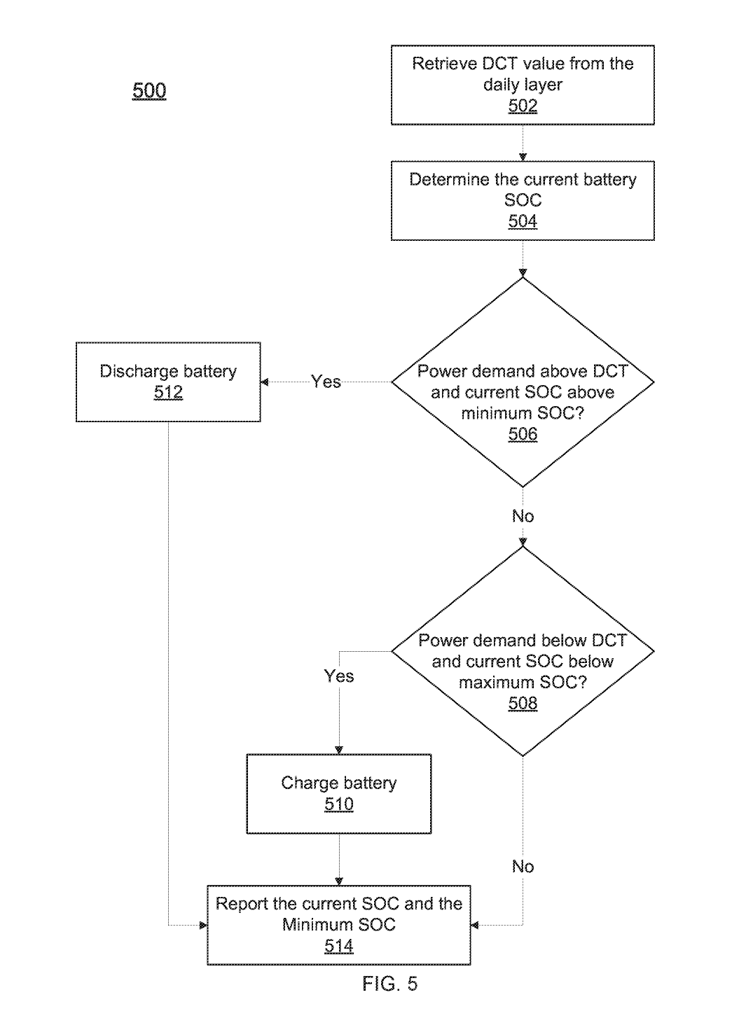

Referring now to FIG. 5, a system/method for a real-time battery storage controller 500 of a multi-layer power demand management controller is illustratively depicted in accordance with an embodiment of the present principles.

A real-time battery storage controller 500 retrieves the latest modified DCT value from the daily layer and controls the batteries of the BTM-EMS according to the modified DCT value.

For example, the real-time battery storage controller 500 will retrieve the modified DCT value from the daily layer 502. The real-time battery storage controller 500 will then determine the current battery SOC. The real-time battery storage controller 500 will then determine whether to charge or discharge the batteries, or to take no action.

At block 506, the real-time battery storage controller 500 will determine if the power demand is above the DCT value, and the current SOC is above the SOCₘᵢₙ. If yes, then at block 512, the real-time battery storage controller 500 will discharge the battery to supplement power from the distribution network. If no, the real-time battery storage controller 500 will proceed to block 508 to determine if power demand is below the DCT value and the current SOC is below SOCₘₐₓ. If yes, the real-time battery storage controller 500 will proceed to block 510 and charge the battery using power from the distributed network.

If block 508 returns no, or the blocks 510 or 512 have been completed, then the real-time battery storage controller 500 will report the current SOC to the daily and monthly layers.

The flowcharts and block diagrams discussed above in regard to the Figures illustrate the architecture, functionality and operation of aspects of the various embodiments of the systems and methods of the present invention. Accordingly, each block in the flowcharts, block diagrams or description may represent a module, component, segment or portion of instructions according aspects of the various embodiments. Additionally, the blocks may occur in alternative orders to those depicted and described, such as subsequent blocks occurring substantially concurrently or in reverse order depending on the functionality involved. Moreover, each block or combinations of blocks may be implemented by special purpose hardware or combinations of special purpose hardware to perform the specified function or combinations of functions.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for adaptive demand charge management in a behind the meter energy management system, comprising:
determining, in a first layer, an initial demand charge threshold (DCT), for a first period, based on historical DCT profiles;
generating recursively, in a second layer, a forecast of a power demand for a second period, wherein the second period is a subset of the first period;
combining the first layer and the second layer to recursively modify the initial DCT with a DCT adjustment value to generate a modified DCT, wherein the DCT adjustment value is optimized according to the forecast of power demand for the second period; and
controlling batteries according to the modified DCT, wherein the batteries are discharged if power demand is above the modified DCT, and the batteries are charged if the power demand is below the modified DCT.

2. The method as recited in claim 1, wherein the first period is one month and the second period is one day.

3. The method as recited in claim 1, wherein each historical DCT profile of the historical DCT profiles includes a time series of optimal DCTs, wherein each optimal DCT corresponds to a period having a same length as the first period.

4. The method as recited in claim 1, further comprising:
selecting the historical DCT profiles according to similarity with a reference DCT profile.

5. The method as recited in claim 4, wherein the selected historical DCT profiles are selected using a similarity selection process including:
determining a reference DCT profile period for a current profile having a period length P, the reference DCT profile period including a time series of reference periods in a most recent period P of operation, the reference periods being of a same length as the first period;
determining an optimal DCT for each reference period to generate a reference DCT profile;
generate a search set including all historical DCT profiles having a profile period of a same length P and sequence as the reference DCT profile period;
normalizing the reference DCT profile and each DCT profile within the search set;
calculating a Euclidean distance between the normalized reference DCT profile and each normalized DCT profile within the search set; and
selecting all normalized DCT profiles within the search set that have a Euclidean distance from the normalized reference DCT profile that is less than a predetermined distance.

6. The method as recited in claim 1, wherein generating the forecast of the power demand includes a short-term forecasting model including training an auto-regressive integrated moving average (ARIMA) model.

7. The method as recited in claim 1, wherein the DCT adjustment value modifies the initial DCT value according to a rolling time horizon optimization function that takes into account at least the initial DCT, a real-time state of charge of the batteries, a real-time power demand, demand charge tariff rates and battery specifications.

8. The method as recited in claim 7, wherein the rolling time horizon optimization function is updated every 15 minutes.

9. The method as recited in claim 1, wherein the DCT adjustment value is optimized to correct an underestimation by the initial DCT for the second period.

10. The method as recited in claim 1, wherein controlling the batteries further includes discharging the batteries when power demand is above the modified DCT and a battery state of charge is above a predetermined minimum state of charge; and
charging the batteries when the power demand is below the modified DCT and the battery state of charge is below a maximum state of charge.

11. A system for adaptive power demand management in a behind the meter energy management system, comprising:
a first layer forecaster, including a processor, configured to determine an initial demand charge threshold (DCT), for a first period, based on historical DCT profiles;
a second layer forecaster configured to generate recursively a forecast of a power demand for a second period, wherein the second period is a subset of the first period;
an optimizer configured to combine the first layer forecaster and the second layer forecaster to recursively modify the initial DCT with a DCT adjustment value to generate a modified DCT, wherein the DCT adjustment value is optimized according to the forecast of power demand for the second period; and
a real-time battery storage controller configured to control batteries according to the modified DCT, wherein the batteries are discharged if power demand is above the modified DCT, and the batteries are charged if the power demand is below the modified DCT.

12. The system as recited in claim 11, wherein the first period is one month and the second period is one day.

13. The system as recited in claim 11, wherein each historical DCT profile of the historical DCT profiles includes a time series of optimal DCTs, wherein each optimal DCT corresponds to a period having a same length as the first period.

14. The system as recited in claim 11, wherein the first layer is further configured to select the historical DCT profiles according to similarity with a reference DCT profile.

15. The system as recited in claim 14, wherein the first layer is further configured to select the historical DCT demand profiles using a similarity selection process including:
determining a reference DCT profile period for a current profile having a period length P, the reference DCT profile period including a time series of reference periods in a most recent period P of operation, the reference periods being of a same length as the first period;
determining an optimal DCT for each reference period to generate a reference DCT profile;
generate a search set including all historical DCT profiles having a profile period of a same length P and sequence as the reference DCT profile period;
normalizing the reference DCT profile and each DCT profile within the search set;
calculating a Euclidean distance between the normalized reference DCT profile and each normalized DCT profile within the search set; and
selecting all normalized DCT profiles within the search set that have a Euclidean distance from the normalized reference DCT profile that is less than a predetermined distance.

16. The system as recited in claim 11, wherein the second layer is configured to generate the forecast of the power demand using a short-term forecasting model including training an auto-regressive integrated moving average (ARIMA) model.

17. The system as recited in claim 11, wherein the optimizer includes a rolling time horizon optimizer that is configured to optimize the DCT adjustment value by taking into account at least the initial DCT, a real-time state of charge of the batteries, a real-time power demand, demand charge tariff rates and battery specifications.

18. The system as recited in claim 17, wherein the rolling time horizon optimizer is updated every 15 minutes.

19. The system as recited in claim 11, wherein the second layer is further configured to optimize the DCT adjustment value to correct an underestimation by the initial DCT for the second period.

20. The system as recited in claim 11, wherein the real-time battery storage controller is further configured:
discharge the batteries when power demand is above the modified DCT and a battery state of charge is above a predetermined minimum state of charge; and
charge the batteries when the power demand is below the modified DCT and the battery state of charge is below a maximum state of charge.
